(19) United States
(12) Patent Application Publication
(10) Pub. No.: US 2014/0049472 A1
(43) Pub. Date: Feb. 20, 2014

(54) ELECTRONIC DEVICE AND METHOD OF DISPLAYING TOUCH KEYBOARD ON TOUCH SCREEN OF THE ELECTRONIC DEVICE

(71) Applicant: HON HAI PRECISION INDUSTRY CO., LTD., New Taipei (TW)

(72) Inventors: HSIAO-PING CHIU, New Taipei (TW); HSUEH-TSEN TSAI, New Taipei (TW)

(73) Assignee: HON HAI PRECISION INDUSTRY CO., LTD., New Taipei (TW)

(21) Appl. No.: 13/957,457

(22) Filed: Aug. 2, 2013

(30) Foreign Application Priority Data
Aug. 14, 2012 (TW) 101129279

(51) Int. Cl. G06F 3/041

(52) U.S. Cl. CPC G06F 3/0412
USPC 345/168

(57) ABSTRACT

In a method of displaying a touch keyboard on a touch screen of an electronic device, one or more control instructions for displaying different keyboard layouts of the touch keyboard on the touch screen are determined. The method determines a keyboard layout of the touch keyboard corresponding to each of the control instructions. When a control instruction is touched on the touch screen, the touch screen displays a keyboard layout of the touch keyboard according to the obtained control instruction.

### BACKGROUND

1. Technical Field

The present disclosure relates to keyboard of electronic devices, and more particularly to an electronic device and method of displaying a touch keyboard on a touch screen of the electronic device.

2. Description of Related Art

A touch keyboard of an electronic device is displayed on a touch screen of the electronic device. The touch keyboard may be a WINDOWS keyboard, or a 3×4 keyboard, for example. A keyboard layout of the touch keyboard is displayed in a fixed manner. However, when customization of the touch keyboard is needed, for example, displaying a number of characters of the touch keyboard that are often used by a user, the touch keyboard is not customizable. The touch keyboard may result in being inconvenient and time wasting. Therefore, there is room for improvement in the art.

### BRIEF DESCRIPTION OF THE DRAWINGS

FIG. 1 is a block diagram of one embodiment of an electronic device including a touch keyboard displaying system.

FIG. 2 is a block diagram of function modules of the touch keyboard displaying system included in the electronic device.

FIG. 3 is a flowchart of one embodiment of a method of displaying a touch keyboard on a touch screen of the electronic device a FIG. 1.

FIG. 4A is a schematic diagram for display a numeric keypad by using a rectangular graphic.

FIG. 4B is a schematic diagram for displaying a customized layout of the touch keyboard by using a triangular graphic.

FIG. 4C is a schematic diagram for displaying the customized layout of touch keyboard by using a parallelogram graphic.

FIG. 4D is a schematic diagram for displaying an original layout of the touch keyboard by using a circular graphic.

FIG. 5 is a schematic diagram of the original layout of the touch keyboard shown in FIG. 4D.

FIG. 6A is a schematic diagram for displaying the rectangular graphic that is touched on the touch screen.

FIG. 6B is a schematic diagram for displaying the numeric keypad corresponding to the rectangular graphic on the touch screen.

FIG. 6C is a schematic diagram for displaying the circular graphic that is touched on the numeric keypad.

FIG. 6D is a schematic diagram for displaying the original layout corresponding to the circular graphic on the touch screen.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage system. The non-transitory computer-readable storage medium may include CDs, DVDs, BLU-RAY, flash memory, and hard disk drives.

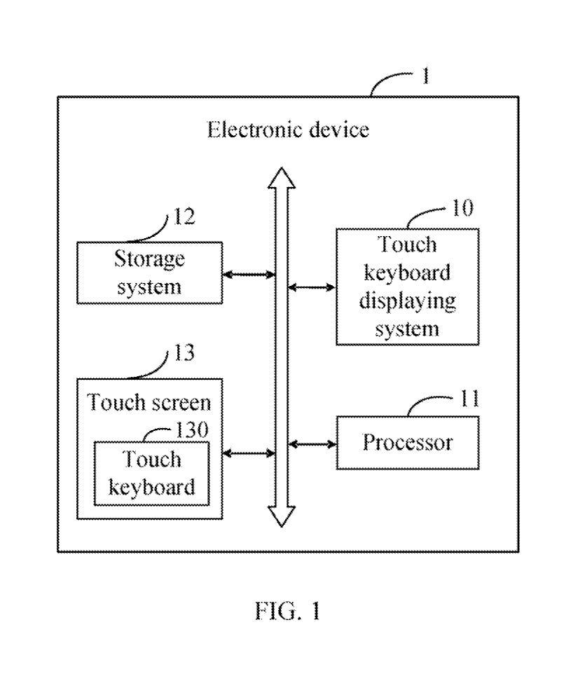

FIG 1 is a block diagram of one embodiment of an electronic device 1 including a touch keyboard displaying system 10. In the embodiment, the electronic device 1 may be a device that includes a touch screen 13, for example, a mobile phone, a notebook computer, or a personal digital assistant (PDA). The touch screen 13 displays a touch keyboard 130 and senses operations touched on the touch keyboard 130. The touch keyboard 130 is a virtual keyboard that receives characters or numbers input to the electronic device 1.

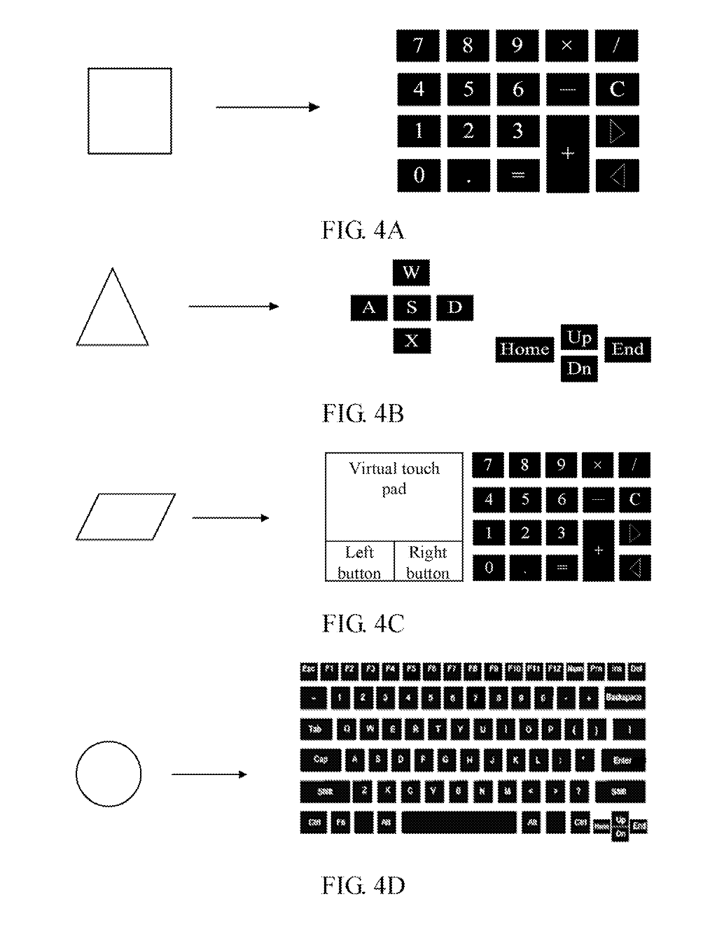

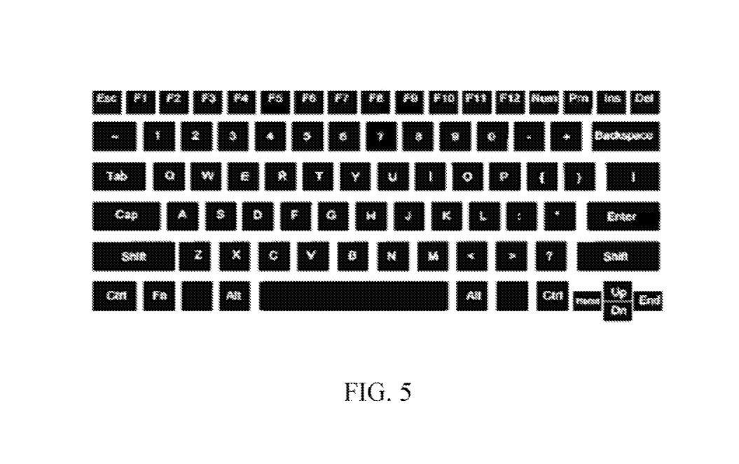

In one embodiment, the touch keyboard 130 may display an original layout or a customized layout. The original layout is a keyboard layout of a keyboard that is installed in the electronic device 1, for example, a keyboard layout of a WINDOWS keyboard, or a keyboard layout of a 3×4 keyboard. As shown in FIG. 5, the original layout is the keyboard layout of the WINDOWS keyboard. The original layout includes a plurality of keys, and one or more characters are displayed on each of the keys. The customized layout is a keyboard layout that displays a number of keys of the original layout, a virtual touch pad, or a combination of the virtual touch pad and a number of keys of the original layout. In one embodiment, as shown in FIG. 4C, the virtual touch pad shares a same configuration and function with a touch pad of a notebook computer. After a character input function of the electronic device 1 is activated, the original layout is displayed on the touch screen 13.

The electronic device 1 further includes at least one processor 11 and a storage system 12. In one embodiment, the storage system 12 may be an internal storage system, such as a random access memory (RAM) for temporary storage of information, and/or a read only memory (ROM) for permanent storage of information. In some embodiments, the storage system 12 may also be an external storage device, such as an external hard disk, a storage card, or a data storage medium. The at least one processor 11 executes one or more computerized codes and other applications of the electronic device 1 to provide the functions of the touch keyboard displaying system 10.

The storage system 12 stores control instructions for displaying different keyboard layouts of the touch keyboard 130, for example, changing from the original layout to the customized layout on the touch screen 13. Each of the control instructions corresponds to a keyboard layout of the touch keyboard 130 displayed on the touch screen 13. The control instructions and the keyboard layout are user-determined or pre-determined. Each of the control instructions may be a graphic, a symbol, a letter, or a gesture for operation, for example. As shown in FIG. 4A, FIG. 4B, FIG. 4C, and FIG. 4D, graphics on the left of arrows are control instructions, and objects on the right of the arrows are keyboard layouts of the touch keyboard 130.

In one embodiment, the control instructions include triggering instructions and returning instructions. Each of the triggering instructions triggers the touch keyboard 130 to display the customized layout on the touch screen 13. As shown in FIG. 4A, FIG. 4B, and FIG. 4C. the control instructions are the triggering instructions. Each of the returning instructions triggers the touch keyboard 130 to display the original layout on the touch screen 13. As shown in FIG. 4D, the control instruction is the returning instruction.

The touch keyboard displaying system 10 can determine control instructions for displaying different keyboard layouts of the touch keyboard 130 on the touch screen 13, and determine a keyboard layout of the touch keyboard 130corresponding to each of the control instructions. The touch keyboard displaying system 10 further obtains a control instruction that is touched on the touch screen 13, and displays a keyboard layout on the touch screen 13 according to the obtained control instruction.

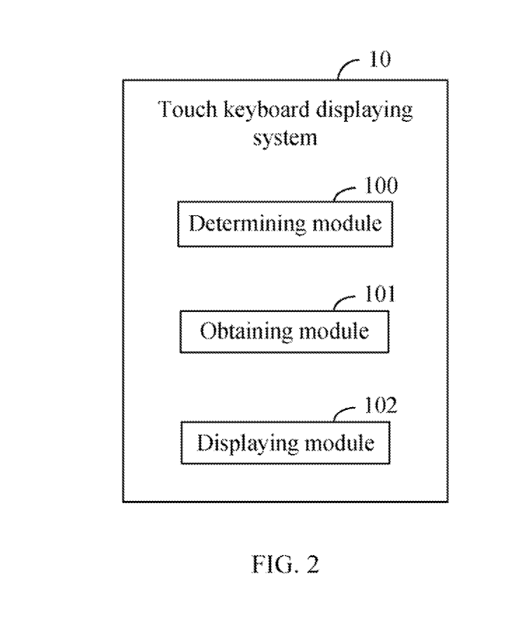

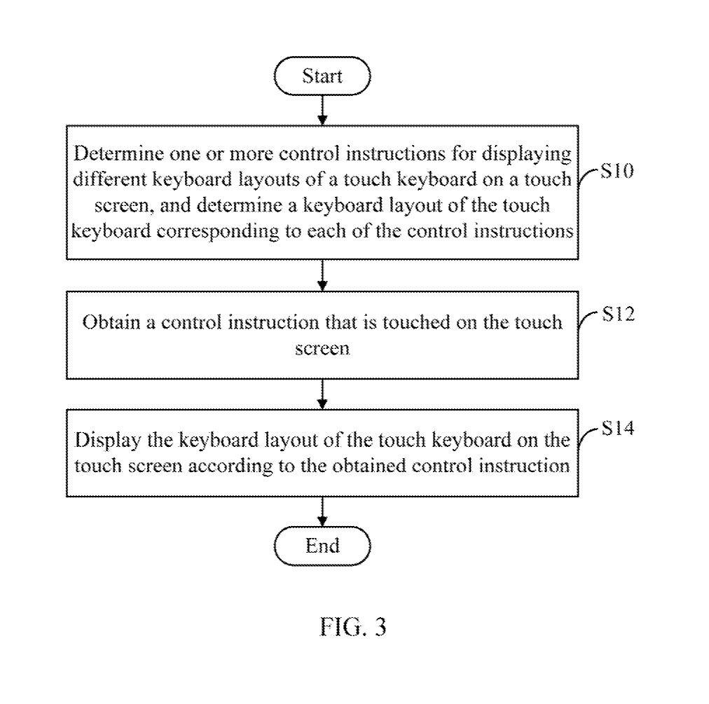

FIG. 2 is a block diagram of function modules of the touch keyboard displaying system 10 included in the electronic device 1 in one embodiment, the touch keyboard displaying system 10 may include a determining module 100, an obtaining module 101, and a displaying module 102. The modules 100-102 comprise computerized codes in the form of one or more programs that are stored in the storage system 12 of the electronic device 1. The computerized codes include instructions that are executed by the at least one processor 11 of the electronic device 1 to provide functions for the modules. Details of each of the modules are given in FIG. 3.

FIG. 3 is a flowchart of one embodiment of a method of displaying a touch keyboard 130 on the touch screen 13 of the electronic device 1 of FIG. 1. Depending on the embodiment, additional steps may be added, others deleted, and the ordering of the steps may be changed.

In step S10, the determining module 100 determines one or more control instructions for displaying different keyboard layouts of the touch keyboard 130 on the touch screen 13, and determines a keyboard layout of the touch keyboard 130 corresponding to each of the control instructions. In one embodiment, each of the control instructions is used to display a keyboard layout of the touch keyboard 130 on the touch screen 13. The control instructions and the keyboard layout are user-determined or pre-determined. Each of the control instructions may be a graphic, a symbol, a letter, or a gesture for operation, for example.

In one embodiment, the keyboard layouts of the touch keyboard 130 include the original layout and the customized layout. The control instructions include triggering instructions and returning instructions. Each of the triggering instructions triggers the touch keyboard 130 to display the customized layout on the touch screen 13. Each of the returning instructions triggers the touch keyboard 130 to display the original layout on the touch screen 13.

As shown in FIG. 4A, the customized layout of the touch keyboard 130 is presented as a numeric keypad. When a user inputs number frequently, a rectangular graphic is touched on the touch screen 13 to turn on the customized layout FIG. 4A. As shown in FIG. 4B, the customized layout of the touch keyboard 130 includes four characters keys and four navigation keys. When the user uses the customized layout of FIG. 4B to play games, a triangular graphic is touched on the touch screen 13 to turn on the customized layout of FIG. 4B. As shown in FIG. 4C, the customized layout of the touch keyboard 130 is presented as a combination of the numeric keypad and the virtual touch pad. When the user inputs number and uses touch pad frequently, a parallelogram graphic is touched on the touch screen 13 to turn on the customized layout of FIG. 4C. As shown in FIG. 4D, when the electronic device 1 returns to the original layout of the touch keyboard 130, a circular graphic is touched on the touch screen 13 to turn on the original layout of FIG. 4D.

In step S12, the obtaining module 101 obtains a control instruction that is touched on the touch screen 13.

In step S14, the displaying module 102 displays the keyboard layout of the touch keyboard 130 on the touch screen 13 according to the obtained control instruction.

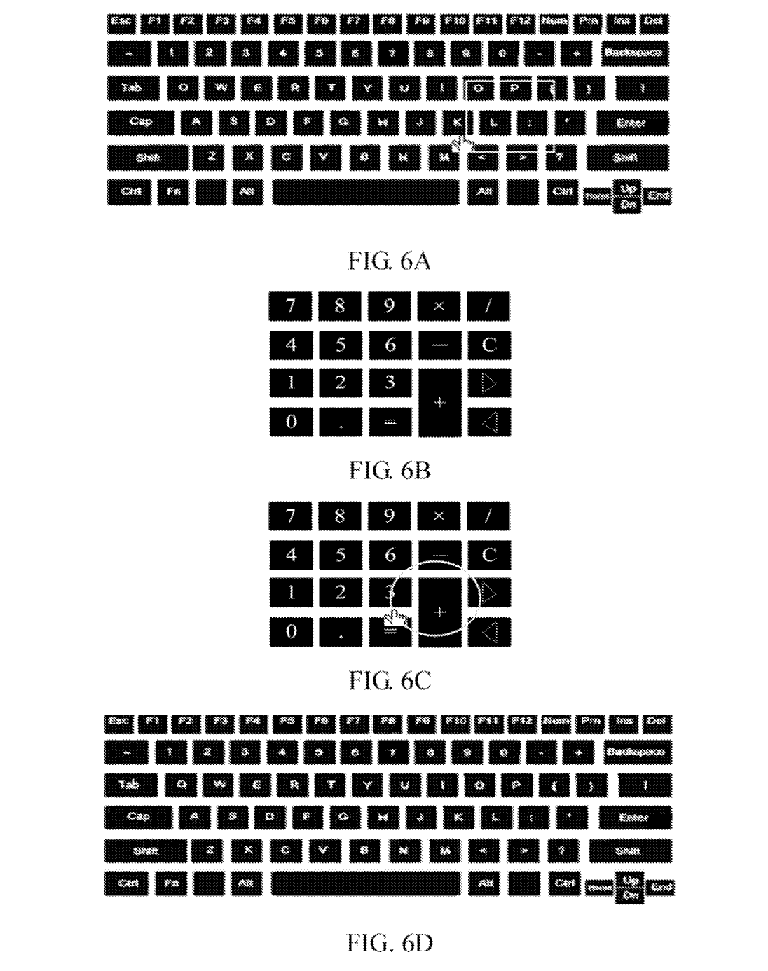

As shown in FIG. 6A, the rectangular graphic is touched on the touch screen 13. As shown in FIG. 6B, the displaying module 102 displays the numeric keypad corresponding to the rectangular graphic on the touch screen 13. As shown in FIG. 6C, the circular graphic is touched on the numeric keypad that displayed on the touch screen 13. As shown in FIG. 6D, the displaying module 102 displays the original layout corresponding to the circular graphic on the touch screen 13.

In this disclosure, the touch keyboard 130 is displayed in different keyboard layouts on the touch screen 13. Each of different keyboard layouts can be determined according to customized requests of the user. Time is not wasted by searching for keys of the touch keyboard 130 and convenience for the user is enhanced.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included within the scope of this disclosure and the described inventive embodiments, and the present disclosure is protected by the following claims.

What is claimed is:

1. A computerized-method of displaying a touch keyboard on a touch screen of an electronic device, the method comprising:
determining one or more control instructions for displaying different keyboard layouts of the touch keyboard on the touch screen, and determining a keyboard layout of the touch keyboard corresponding to each of the control instructions;
obtaining a control instruction that is touched on the touch screen; and
displaying the keyboard layout of the touch keyboard on the touch screen according to the obtained control instruction.

2. The method as claimed in claim 1, wherein each of the control instructions is a graphic, a symbol, a letter, or a gesture for operation.

3. The method as claimed in claim 1, wherein the keyboard layout of the touch keyboard is an original layout, or a customized layout.

4. The method as claimed in claim 3, wherein the control instructions include triggering instructions, and each of the triggering instructions triggers the touch keyboard to display the customized layout on the touch screen.

5. The method as claimed in claim 3, wherein the control instructions include returning instructions, and each of the returning instructions triggers the touch keyboard to display the original layout on the touch screen.

6. A non-transitory computer readable storage medium storing a set of instructions that, when executed by at least one processor of an electronic device, causes the at least one processor to perform a method of displaying a touch keyboard on a touch screen of the electronic device, the method comprising:
determining one or more control instructions for displaying different keyboard layouts of the touch keyboard on the touch screen, and determining a keyboard layout of the touch keyboard corresponding to each of the control instructions;
obtaining a control instruction that is touched on the touch screen; and
displaying the keyboard layout of the touch keyboard on the touch screen according to the obtained control instruction.

7. The storage medium as claimed in claim 6, wherein each of the control instructions is a graphic, a symbol, a letter, or a gesture for operation.

8. The storage medium as claimed in claim 6, wherein the keyboard layout of the touch keyboard is an original layout, or a customized layout.

9. The storage medium as claimed in claim 8, wherein the control instructions include triggering instructions, and each of the triggering instructions triggers the touch keyboard to display the customized layout on the touch screen.

10. The storage medium as claimed in claim 8, wherein the control instructions include returning instructions, and each of the returning instructions triggers the touch keyboard to display the original layout on the touch screen.

11. An electronic device, comprising:
a touch screen;
at least one processor; and
a non-transitory storage medium storing one or more programs, which when executed by the at least one processor, causes the at least one processor to:
determine one or more control instructions for displaying different keyboard layouts of a touch keyboard on the touch screen, and determine a keyboard layout of the touch keyboard corresponding to each of the control instructions;
obtain a control instruction that is touched on the touch screen; and
display the keyboard layout of the touch keyboard on the touch screen according to the obtained control instruction.

12. The electronic device as claimed in claim 11, wherein each of the control instructions is a graphic, a symbol, a letter, or a gesture for operation.

13. The electronic device as claimed in claim 11, wherein the keyboard layout of the touch keyboard is an original layout, or a customized layout.

14. The electronic device as claimed in claim 13, wherein the control instructions include triggering instructions, and each of the triggering instructions triggers the touch keyboard to display the customized layout on the touch screen.

15. The electronic device as claimed in claim 13, wherein the control instructions include returning instructions, and each of the returning instructions triggers the touch keyboard to display the original layout on the touch screen.
